(19) United States
(12) Patent Application Publication
(10) Pub. No.: US 2021/0316239 A1
(43) Pub. Date: Oct. 14, 2021

(54) FIRE-RESISTANT FILTER

(71) Applicant: 3M INNOVATIVE PROPERTIES COMPANY, St. Paul, MN (US)

(72) Inventors: Matthew W. Gorrell, South St. Paul, MN (US); Hannah L. Stoughton, Afton, MN (US); Windy A. Santa Cruz, Minneapolis, MN (US); Christine L. McCool, St. Paul, MN (US); Tommie W. Kelley, Shoreview, MN (US); John B. Stender, St. Paul, MN (US); Blake R. Griffith, Oakdale, MN (US); John M. Brandner, St. Paul, MN (US); Yaohua Gao, Woodbury, MN (US); Stephen M. Sanocki, Stillwater, MN (US); Joseph A. Dunbar, Woodbury, MN (US)

(21) Appl. No.: 17/273,351

(22) PCT Filed: Sep. 6, 2019
(86) PCT No.: PCT/IB2019/057538

§ 371 Date: Mar. 4, 2021

Related U.S. Application Data
(60) Provisional application No. 62/728,562, filed on Sep. 7, 2018.

(51) Int. Cl. B01D 39/16; B01D 46/00; B01D 46/16; F24C 15/20

(52) U.S. Cl. CPC B01D 39/163; B01D 46/0002; B01D 46/16; B01D 2239/10; B01D 2239/0457; B01D 2239/0618; B01D 2239/0636; F24C 15/2035

(57) ABSTRACT

Various embodiments disclosed relate to a fire-resistant filter and methods of making and using the same. A filter includes a fibrous web or sheet comprising fire-resistant fibers, the fire-resistant fibers comprising oxidized polyacrylonitrile (OPAN), flame-retardant (FR) rayon, or a combination thereof.

### BACKGROUND

Many commercial and residential kitchens have grease filtration or removal systems installed in exhaust hoods above various types of cooking equipment, including deep-fat fryers, grills, griddles, woks, and ovens where grease can become aerosolized and where excess heat and flame can occur.

The baffle is a key component of an exhaust hood construction. The baffle is a device inserted into an exhaust hood that acts to filter the aerosolized grease. The baffle causes perturbations in air passing through channels in the baffle, which in turn can lead to grease droplets colliding with and condensing on the surface of the baffle.

In this system, baffles need to be removed from the exhaust hood and cleaned on a regular basis. Because baffles do not capture all of the grease entering the exhaust hood, the interior of an exhaust hood also needs to be cleaned on a regular basis. Both of these cleaning processes can be time consuming and costly. These cleaning processes often require the use of harsh chemicals that can contaminate food surfaces they may come into contact with. Additionally, because of complexity of cleaning an exhaust hood, this activity typically requires that the kitchen, or at least the cooking equipment, is not in use. Because of this, cleaning is often required to happen during times a kitchen or business is closed, or the business is required to close to allow for opportunity for cleaning.

When baffles are removed and replaced, this can be a difficult process for a worker in a kitchen to perform because baffles are often quite heavy, and must be held overhead and placed into the correct channel in an exhaust hood system.

Existing filters or secondary filters are heavy, expensive, and provide insufficient fire-resistance without being backed by a baffle.

### SUMMARY OF THE INVENTION

Various embodiments of the present invention provide a filter including a fibrous web or sheet including fire-resistant fibers. The fire-resistant fibers include oxidized polyacrylonitrile (OPAN), flame-retardant (FR) rayon, or a combination thereof.

Various embodiments of the present invention provide a filter assembly including the filter including the fibrous web or sheet including fire-resistant fibers. The filter assembly also includes a filter frame.

Various embodiments of the present invention provide a self-supporting filter assembly that includes a fibrous non-woven web or sheet including fire-resistant fibers. The fire-resistant fibers include OPAN, FR rayon, or a combination thereof. The OPAN, FR rayon, or combination thereof, is at least about 60 wt % of the fibrous web or sheet. The self-supporting filter assembly also includes a filter frame.

Various embodiments provide a method of using the filter including the fibrous web or sheet including fire-resistant fibers. The method includes mounting the filter or a filter assembly including the filter for air to be filtered therethrough.

Various embodiments provide a method of using the filter including the fibrous web or sheet including fire-resistant fibers. The method includes filtering air through the filter.

Various embodiments of the present invention provide a method of making an embodiment of the filter. The method includes forming the fibrous web or sheet including the fire-resistant fibers including OPAN, FR rayon, or a combination thereof.

In some embodiments, the filter including the fibrous web or sheet including fire-resistant fibers, or methods or making or using the same, can have certain advantages over other filters, at least some of which are unexpected. For example, in some embodiments, the filter can have better fire-resistance than other oleophilic filters. In some embodiments, the filter can have better acoustic effects than other filters, and can more effectively dampen noise effects in the vent and hood system. In various embodiments, as compared to other fire-resistant filters, the filter of the present invention can have lower weight, a decreased manufacturing cost, or a combination thereof. In various embodiments, the lower weight can correspond to less waste when used in a disposable application, and can result in enhanced safety as well as easier installation.

In various embodiments, the fire-resistant filter can have enhanced oleophilic properties compared to other fire-resistant filters, allowing a reduced or eliminated need for baffle and air duct cleaning, providing a corresponding decrease in maintenance cost. In some embodiments, the fire-resistant filter can be disposable or can be cleaned and reused. By reducing the build-up of grease in an exhaust hood, the risk of duct fires is decreased Enhanced capture of grease particles can also reduce ambient emissions into the neighborhood that can create buildup on the roof and exposure of the neighborhood to grease emissions and odors. Reduced grease build-up in the hood can reduce worker exposure to the hazard of climbing on ladders or equipment to remove and replace standard baffles.

In various embodiments, the enhanced fire resistance of the filter can allow a filter assembly of the present invention including the filter and including a filter frame to have greater open area that is useful for filtration and that is not obscured by the filter frame than other fire-resistant filter assemblies that rely on the fire-resistant properties of the filter frame to provide fire-resistance to the assembly. In various embodiments, the greater open area of filter assemblies of the present invention allows more efficient filtration per surface area of the filter assembly, as compared to other filter assemblies made using less fire-resistant filters and requiring more blockage of open area with fire-resistant filter frame to achieve the desired level of fire-resistance. In various embodiments, the greater open area can make a filter assembly of the present invention more visually attractive than other similar fire-resistant filters.

### BRIEF DESCRIPTION OF THE FIGURES

The drawings illustrate generally, by way of example, but not by way of limitation, various embodiments of the present invention.

FIG. 1A is an image of a commercial kitchen with baffles.

FIG. 1B is an image of a baffle used for grease capture.

FIG. 2A is a diagram of a cross-section of a ventilation hood.

FIG. 2B is a diagram of a cross-section of a traditional baffle.

FIG. 3 illustrates a filter assembly, in accordance with various embodiments.

FIG. 4 illustrates a filter frame, in accordance with various embodiments.

FIG. 5A is an image of a multilayer filter, in accordance with various embodiments.

FIG. 5B is an image of a multilayer filter, in accordance with various embodiments.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

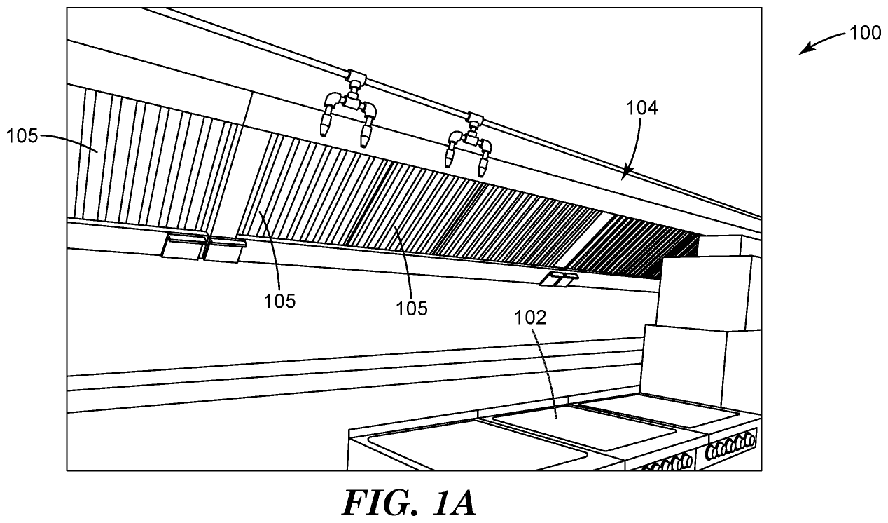

FIG. 1A shows an image of an exemplary commercial kitchen 100 including a cooking surface 102 used to cook a variety of (often greasy) foods at high heats. Ventilation hood system 104 is positioned near the cooking surface to allow an outlet for oily steam or mist rising from the cooking surface 102. Baffles 105 are positioned in the ventilation hood system 104 near the cooking surface 102 so that oily steam rising from the cooking surface 102 must first pass through a baffle to exit through the ventilation hood system 104.

FIG. 1B shows a traditional baffle 110. Traditional baffles 110 are often made of a metal such as stainless steel, aluminum, or other metals and can weigh in the range of 1 kilogram to 3 kilograms. Baffle may have handles 112 on a front of the baffle to aid in placement and removal of the baffles. Baffles can be very cumbersome to manage when placing into an overhead ventilation hood system, and, in particular, the edge 114 of baffle 110 fits into a lip in a ventilation hood system. It can be challenging to correctly position a baffle 110 to fit in the lip in the ventilation hood system due to the fact that baffles are typically located over a user's head and can be bulky and heavy. Even in an ideal kitchen, appliances or other objects often complicate the positioning of baffles, especially in an environment with elevated temperatures and slippery surfaces.

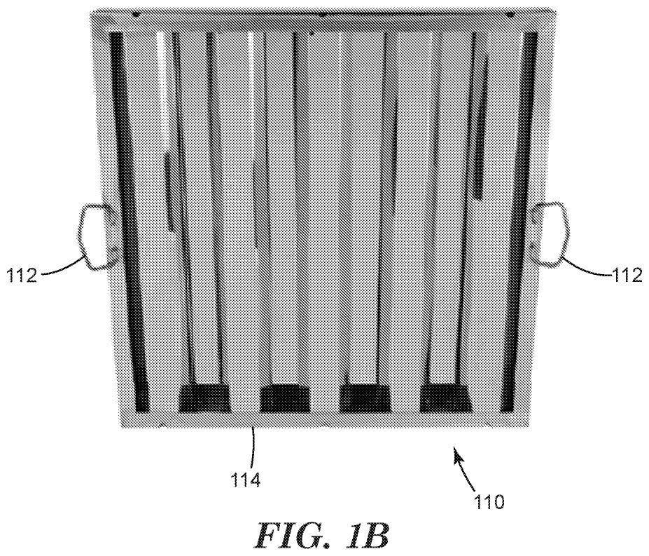

FIG. 2A is a diagram of a cross section of a ventilation hood system 200. Air (often oily mist) flows in the direction of arrow 211 through baffle 220 and out exhaust duct 212, in the direction of arrow 213. Baffle 220 is the primary grease collection element air must pass through before exiting the exhaust duct 212. Because baffles 220 are not traditionally very effective at capturing grease, a substantial amount of grease typically exits the kitchen into the environment, collecting in the exhaust duct and on the exterior of a building in the area of the exhaust duct 212. This can create environmental pollution along with increased fire hazard created by the grease coating throughout the ventilation hood system 200 and on the exterior of the building.

FIG. 2B is a cross section of a traditional baffle 220. Arrows 225 show the movement of oily mist or grease laden air around the structure of the baffle plates 227. The turbulence created by the air flowing around the baffle plates 227 results in grease or oil droplets coming into contact with the baffle plates and collecting or condensing on the baffle 220. Baffles are required to be cleaned on a regular basis to remove the collected oil, and are relatively inefficient at collecting oil, resulting in a substantial amount of grease laden air entering the ventilation hood system and collecting throughout the system and on the exterior of the building the system is installed in.

### Fire-Resistant Filter.

In various embodiments, the present invention provides a fire-resistant filter. The filter includes a fibrous web or sheet including fire-resistant fibers. The fire-resistant fibers include oxidized polyacrylonitrile (OPAN), flame-retardant (FR) rayon, or a combination thereof. The fibrous web or sheet can be flexible. The filter or the fibrous web or sheet, is generally planar in shape, and can be pleated, flat, or a combination thereof. The fibrous web or sheet can form substantially the entirety of the fire-resistant filter, or the filter can include other layers, reinforcement (e.g., a filter frame), coatings, and the like.

The filter, or filter assembly including the filter, can be suitable for mounting in an air filter holder, such as in a slot, with magnets or adhesive, with mechanical fasteners, as a self-supporting filter, with a cover screen to hold the air filter in place, via a frame or fascia for the filter that can be temporarily or permanently attached, or a combination thereof.

In some embodiments, the filter or filter assembly including the filter may have a pull tab that extends beyond the filter, or the filter frame so that a user can grasp the pull tab with one hand and grasp the filter frame with another hand to separate the filter or filter assembly from the frame. The ability to manually separate the filter from the filter frame with reasonable ease allows a user to recycle or reuse the filter frame and appropriately dispose of the grease-impregnated filter. In some instances, the filter frame may have a pull tab. Such a pull tab may be used instead of or in addition to a pull tab on the filter or filter assembly. In some instances, the filter frame may be reused or recycled at a central facility. Filter or filter assembly and filter frame attached to each other using any other attachment mechanism as contemplated herein may also include a system where the filter frame may be reused or recycled. In some instances, the filter, filter frame or the entire assembly may be disposable.

The fibrous web or sheet of the fire-resistant filter can pass the Bunsen Burner Flame Test, as described in the Examples section of the present application, without the aid of any other layers such as a metal baffle. For example, a 10 cm×10 cm sample of the fibrous web or sheet placed 6 cm over a 10 cm-long flame from a natural gas Bunsen burner can remain intact and experience no penetration from the flame after a 10-second exposure to the flame followed by a 10-second removal of the flame and further followed by another 10-second exposure to the flame. A sample can “brown” without burning and still pass this test.

The fire-resistant fibers that form the fibrous web or sheet can be formed into the fibrous web or sheet in any suitable way, such that the fibrous web or sheet provides the fire-resistance described herein. For example, the fibrous web or sheet can be non-woven (e.g., lofty, carded, air-laid, or mechanically bonded, such as spun-lace, needle-entangled, or needle-tacked), woven, knitted, mesh, or perforated film. The fibrous web or sheet can be bonded (e.g., the fibers are bonded to one another at various locations) or non-bonded.

The fibrous web or sheet can be bonded and can include a heat-setting material or a melt material that provides some or all of the bonding in the fibrous web or sheet, such as a flake, powder, fiber, or combination thereof, such as including any suitable thermoplastic or thermoset polymer, such as polyester, polyethylene terephthalate (PET), polypropylene (PP), or a combination thereof. After melting or heating bonding, the flake, powder, or fiber can melt and bond fibers together. The bonding of the fibrous web or sheet can provide increased stability and strength of the filter. The fibrous web or sheet can include any suitable material or fiber in addition to the fire-resistant fibers including OPAN, FR rayon, or a combination thereof. For example, the fibrous web or sheet can include polyacrylonitrile (PAN), polyphenylene sulfide (PPS), polyethylene terephthalate (PET), polypropylene (PP), kapok fiber, poly(lactic acid) (PLA), cotton, nylon, polyester, rayon (e.g., non-flame-retardant rayon), wool, or a combination thereof. The fibrous web or sheet can further include a coating, a flame retardant, fibers, a heat-setting or melt material (e.g., powder, flakes, or fibers), a metal fiber, a glass fiber, a ceramic fiber, an aramid fiber, a sorbent, an intumescent material (e.g., a fiber or a particle), mica, diatomaceous earth, glass bubbles, carbon particles, or a combination thereof. Examples of fibers that can be added include larger diameter fibers that could be added to give more loft and body. Other fibers can be added to give special properties such as hollow fibers or core-sheath fibers, such as to give enhanced oleophilic or oleophobic properties to the filter. Examples of flame retardants include any polymer designated as flame-retardant or “FR”, or can include (e.g., as pure materials or as compounds including the materials) aluminum, polyphosphate, phosphorus, nitrogen, sulfur, silicon, antimony, chlorine, bromine, magnesium, zinc, carbon, or a combination thereof. Flame retardants can be halogen-containing flame retardants or non-halogenated flame retardants. Examples of coatings or additives include expandable graphite, vermiculite, ammonium polyphosphate, alumina trihydrate (ATH), magnesium hydroxide (Mg(OH)2), aluminum hydroxide (Al(OH)3), molybdate compounds, chlorinated compounds, brominated compounds, antimony oxides, organophosphorus compounds, or a combination thereof.

The fibrous web or sheet can have any suitable overall density, such as about 10 to about 400 g/m², or about 80 to about 250 g/m², or about 10 g/m² or less, or less than, equal to, or greater than about 20 g/m², 40, 60, 80, 100, 125, 150, 175, 200, 225, 250, 275, 300, 325, 350, 375, or about 400 g/m² or more.

The filter includes at least one layer of the fibrous web or sheet including the fire-resistant fibers. The filter can include a single layer of the fibrous web or sheet including the fire-resistant fibers or multiple layers of the fibrous web or sheet. The multiple layers can independently be adjacent or separate within the filter. For example, the filter can include 1, 2, 3, 4, 5, 6, 7, 8, 9, or 10 or more layers of the fibrous web or sheet.

The filter can include other layers in addition to the one or more layers of the fibrous web or sheet including the fire-resistant fibers. In some embodiments, one major face of the fibrous web or sheet includes an additional layer and the opposite major face of the fibrous web or sheet is free of additional layers. In some embodiments, both major faces of the fibrous web or sheet include an additional layer. The one or more layers can be independently discrete or at least partially blended. The one or more layers can be blended with adjacent layers, such as each other the one or more layers of the fibrous web or sheet including the fire-resistant fibers.

The one or more additional layers can be any suitable layer, such as a fire-retardant layer (e.g., thin sheets of fire-retardant material such as Nextel™ Dot Paper, or other thin webs composed of ceramic, metal, glass or other fire-retardant/fire-resistant fibers), a non-fire-retardant layer, a woven layer, a non-woven layer, a metal layer (e.g., thin metal or foil that is perforated, or expanded metal), an adhesive layer, a coating, a powder, a sorbent layer, a gradient layer (e.g., a gradient layer that pulls grease into the interior or edges using condensation management film or thermally induced phase separation materials that have high affinity for oil/grease), a sacrificial layer (e.g., layers that could be stripped off as they become saturated with grease, with additional sacrificial layers already present or being added after stripping the disposable layer), grease-degrading layers (e.g., enzymes or microbes), a resin layer, a scrim layer, or a combination thereof. The one or more additional layers can each independently include a fire-retardant, an adhesive, a heat-setting or melt material (e.g., fiber, powder, or flake), a fire-resistant fiber, a coated fiber, powder, metal, glass, ceramic, a metal fiber, a glass fiber, an aramid fiber, a ceramic fiber, a sorbent, an intumescent material (e.g., a fiber or a particle), mica, diatomaceous earth, glass bubbles, carbon particles, or a combination thereof. The one or more additional layers can each independently be unbonded, adhesive-laminated, heat-bonded, ultrasonically bonded, needle-tacked, physically attached by fasteners, or a combination thereof.

In some instances, the filter can include materials contained between two layers of scrim. In some instances, scrim can be used to reduce shedding of fibers from the filter including the fire-resistant fibers, such as to help ensure that fibers or other loose materials from the filter do not fall into a food cooking or handling area. Examples of such materials include activated carbon, oil absorbing particles, vermiculite, or a combination thereof. Examples of scrim materials can include mesh formed from polymer or metal, non-woven materials made from polymer, fibers (e.g., ceramic, glass, or aramid fibers), perforated film made of polymer or metal, and combinations thereof. Scrim materials can be optionally fire-resistant, such as including metals, ceramics, glass, FR rayon, OPAN, and aramid fibers (Kevlar and Nomex). Scrim materials can be coated with a fire retardant such as ammonium polyphosphate. Scrim materials that could be coated with a fire retardant can include polyethylene terephthalate (PET) or nylon. In some instances, the filter can include fire-resistant materials surrounding or sandwiching a layer of a different layer, which may be non-fire-resistant.

### Fire-Resistant Fibers.

The fire-resistant filter includes a fibrous web or sheet. The fibrous web or sheet includes fire-resistant fibers. The fire-resistant fibers include OPAN, flame-retardant (FR) rayon, or a combination thereof. The fire-resistant fibers can be oleophilic, or non-oleophilic (e.g., oleophobic, or neither oleophilic nor oleophobic).

Any suitable proportion of each fire-resistant resistant fibers can be OPAN, FR rayon, or a combination thereof. For example, about 60 wt % to about 100 wt % of each of the fire-resistant fibers can be OPAN, FR rayon, or a combination thereof, or about 90 wt % to about 100 wt %, or about 60 wt % or less, or less than, equal to, or greater than about 65 wt %, 70, 75, 80, 85, 90, 91, 92, 93, 94, 95, 96, 97, 98, 99, 99.5, 99.9, 99.99, or about 99.999 wt % or more. In some embodiments, the fire-resistant fibers are each independently 100 wt % OPAN or 100 wt % FR rayon, and the fire-resistant fibers are not composed of blends of materials but are, rather, each substantially formed from one material.

The FR rayon is a regenerated cellulose (viscose) that includes one or more flame-retardant additives. The flame retardant can be any suitable flame retardant described herein, such as a flame retardant containing phosphorus, sulfur, nitrogen, silicon, or a combination hereof. The flame retardant can include organophosphorus, silica, polysilicic acid, complexes of polysilicic acid, or combination thereof. The flame-retardant can include phosphorus and sulfur, such as 2,2′-oxybis[5,5-dimethyl-1,3,2-dioxaphosphorinane] 2,2′-disulphide. The one or more flame retardants can be incorporated throughout the FR rayon, can be present as a coating on the rayon, or a combination thereof. The one or more flame retardants can form any suitable proportion of the FR rayon, such as about 0.001 wt % to about 50 wt %, or about 0.001 wt % to about 25 wt %, or about 0.001 wt % to about 10 wt %, or about 0.001 wt % to about 5 wt %, or about 0.001 wt % or less, or less than, equal to, or greater than about 0.01 wt %, 0.1, 1, 2, 3, 4, 5, 6, 8, 10, 12, 14, 16, 18, 20, 22, 24, 25, 30, 35, 40, 45, or about 50 wt % or more.

The OPAN, FR rayon, or combination thereof from the fire-resistant fibers can form any suitable proportion of the overall fibrous web or sheet. For example, the OPAN, FR rayon, or combination thereof, can be at least about 50 wt % of the fibrous web or sheet, or at least about 60 wt %, at least about 70 wt %, or about 50 wt % to about 100 wt %, or about 60 wt % to about 100 wt %, or about 70 wt % to about 100 wt %, or about 50 wt % or less, or less than, equal to, or greater than about 52 wt %, 54, 56, 58, 60, 62, 64, 66, 68, 70, 72, 74, 76, 78, 80, 82, 84, 86, 88, 90, 92, 94, 95, 96, 97, 98, 99, 99.5, 99.9, 99.99, or about 99.999 wt % or more. The fibrous web or sheet can include at least 25 g/m² of the OPAN, FR rayon, or combination thereof, or at least 50 g/m², or about 25 g/m² or less, or less than, equal to, or greater than about 30 g/m², 40, 50, 60, 70, 80, 90, 100, 125, 150, 175, 200, 225, 250, 275, 300, 325, 350, 375, or about 400 g/m² or more. Herein, references to properties per area of the filter are with respect to the planar surface area of the major faces of the filter.

The fire-resistant fibers can have any suitable diameter and length such that they provide the fire-resistant properties described herein. For example, the fire-resistant fibers can have a linear mass density of about 0.5 to about 20 denier, or about 3 to about 7 denier, or about 0.5 or less, or less than, equal to, or greater than about 1 denier, 1.5, 2, 2.5, 3, 3.5, 4, 4.5, 5, 5.5, 6, 6.5, 7, 8, 9, 10, 11, 12, 13, 14, 15, 16, 18, or about 20 denier or more. As used herein, “denier” refers to a unit of linear mass density of the fibers, and is the mass in grams per 9000 meters of the fiber. As used herein, “dtex” refers to the mass in grams per 10,000 meters of the fiber. The fire-resistant fibers can have a length of about 0.001 cm to about 10 cm, or about 2 cm to about 8 cm, or about 0.001 cm or less, or less than, equal to, or greater than about 0.01 cm, 0.1, 1, 1.5, 2, 2.5, 3, 3.5, 4, 4.5, 5, 5.5, 6, 6.5, 7, 7.5, 8, 8.5, 9, 9.5, or about 10 cm or more.

### Filter Assembly Including the Fire-Resistant Filter.

In various embodiments, the present invention provides a filter assembly. The filter assembly includes an embodiment of the fire-resistant filter including the fibrous web or sheet including fire-resistant fibers. The filter assembly also includes a filter frame. The filter frame can be flexible or rigid.

The filter frame can provide structural support for the filter assembly. While the fibrous web or sheet including the fire-resistant fibers is typically flexible, the filter frame can be a rigid, self-supporting structure, that provides a rigid and self-supporting filter assembly when combined with the filter including the fire-resistant fibers.

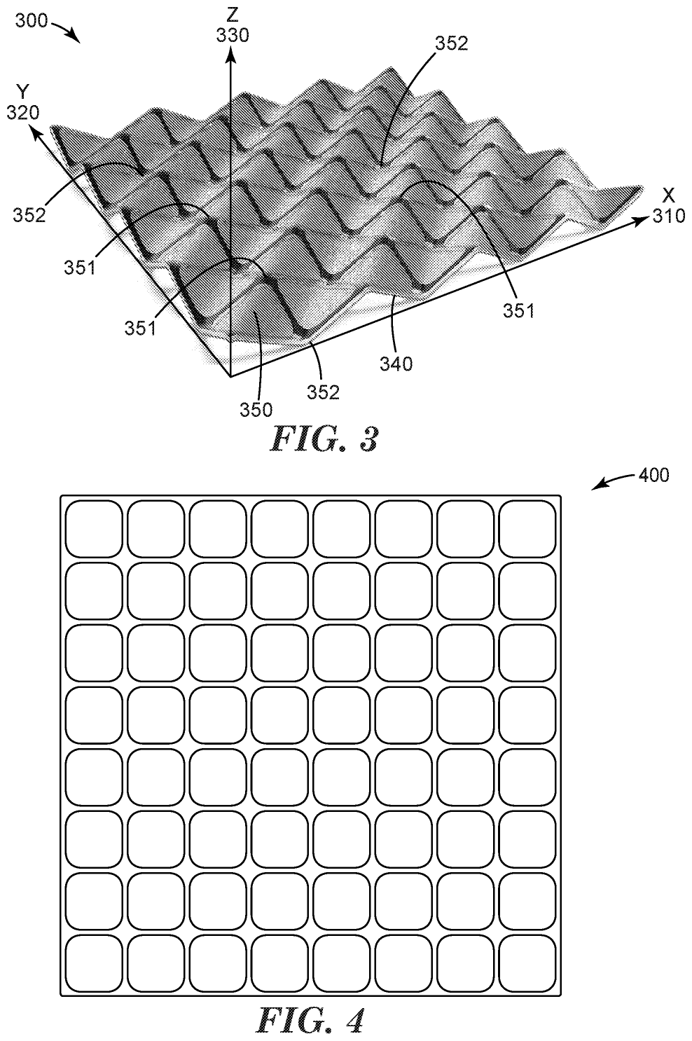

The filter frame can be external to the filter, internal to the filter (e.g., does not extend outside of or around the edge of the filter), or a combination thereof. The filter frame can include supporting cross-members on the front, back, or both sides of the filter formed from thin materials. The filter frame can have a mesh or expanded metal structure with or without a frame structure around the border of the filter frame. The filter frame can have a gridded profile when viewed from the major face, and can be flat or textured. For example, FIG. 4 illustrates filter frame 300 having a gridded profile. The frame or mesh structure can be formed from metals, resins, foams, clays, silica, or a combination thereof. The filter frame can be coated or uncoated.

The filter frame and the filter can be secured to one another. For example, the filter frame can be secured within the interior of the filter, the filter frame can be secured to the one or more portions of the exterior of the filter, or a combination thereof. The filter frame can be secured to the filter in any suitable way, such as using ultrasonic bonding, adhesive, heat bonding, a mechanical attachment mechanism, or a combination thereof.

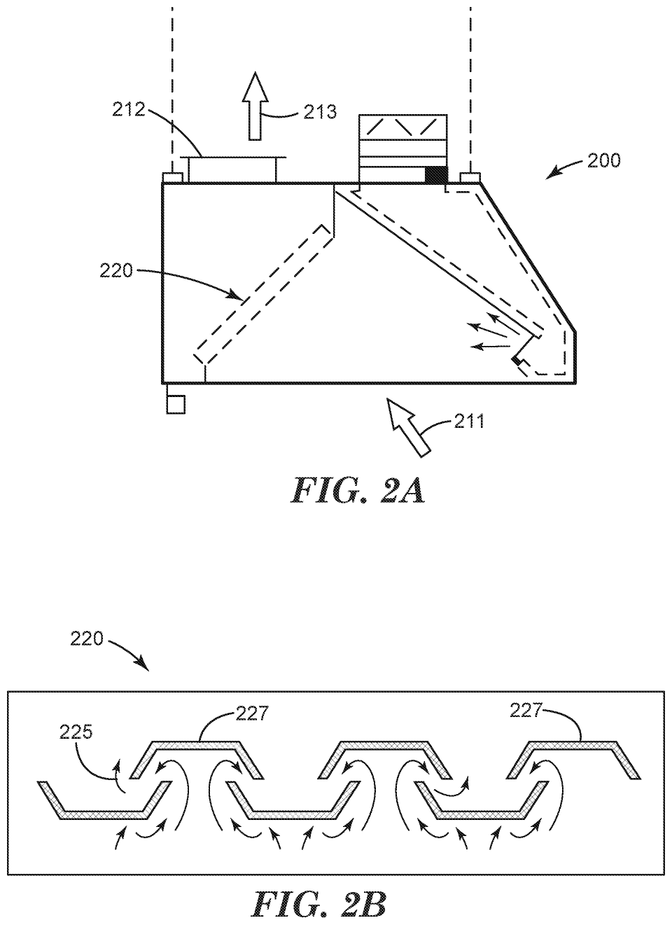

FIG. 3 illustrates an embodiment of the filter assembly including the fire-resistant filter. A self-supporting filter assembly or filter frame generally has rigidity such that if held horizontally from one edge or corner by a user, the filter assembly or filter frame will maintain substantially the same shape as if it were sitting on a flat surface. Embodiments of the filter assembly can be used in the place of a baffle in a grease ventilation hood system.

Filter assembly 300 is positioned in reference to an x-axis 310, y-axis 320 and z-axis 330. Filter assembly 300 has two main parts: filter frame 340 and filter 350 including the fibrous web or sheet including the fire-resistant fibers. As shown in FIG. 3, filter frame 340 is disposed on one major side of filter 350. While filter frame 340 does not extend to contact the edges of filter 350 as shown in FIG. 3, in some instances, filter frame 340 may extend to contact the edges of filter 350. In some instances, filter frame 340 may extend beyond the edges of filter 350 to overlap with the frame in the ventilation hood for the filter or with an adjacent filter. In some instances, this overlap can be used to form a loose seal or a gasket with a ventilation hood or system. In this instance, the edges of filter 350 may not extend to the second major side of the filter.

In some embodiments, the filter frame can be flat. In other embodiments, the filter frame can be textured. For example, filter frame 340 has a plurality of peaks 351 and a plurality of valleys 352. The plurality of peaks 351 and the plurality of valleys extend in two dimensions, such that if a cross section of filter assembly 300 was taken parallel to the x-axis 310 or parallel to the y-axis 320, each cross section would include a plurality of peaks 351 and a plurality of valleys 352. The height difference between a peak 351 and a valley 352 as measured along the z-axis 330 may vary based on the embodiment. In some instances, the height difference may be the same between any chose peak 351 and between any chosen valley 352. In other instances, peaks 351 and valleys 352 may be of varying heights. In one instance, the height difference between one of the plurality of peaks 351 and one of the plurality of valleys 352 is greater than 0.75 cm. It may be greater than 1 cm, 1.5 cm, 2 cm, 2.5 cm, 3 cm, 3.5 cm, 4 cm or 5 cm. In some instances, the height difference between the one of the plurality of peaks 351 and one of the plurality of valleys 352 may be less than 10 cm. In some instances, where the height difference between a peak 351 and a valley 352 varies depending on which peak 351 and which valley 352 is chosen, the height difference may be measured as the greatest distance along the z-axis between any peak 351 and any valley 352.

The filter can substantially conform to the shape of the filter frame. For example, filter 350 may substantially conform to the peaks 351 and valleys 352 of filter frame 340 such that in some instances, filter 350 may be secured to one or more of the peaks 351 and one or more of the valleys 352. Filter 350 may generally follow the curvature of filter frame 340, and in some instances, filter 350 may contact the filter frame at the peaks 351 and valleys 352.

The filter frame can be formed of or coated with any suitable one or more materials such that sufficient structural stability, fire-resistance, or a combination thereof, is provided to the filter assembly. The filter frame can include aluminum, stainless steel, tin, copper, glass, fiberglass, a polyimides (PI), a polybenzoxazole (PBO), a polybenzimidazole (PBI), a polybenzthiazole (PBT), a polyetherimide (PEI), a polyethylene terephthalate polyester (PET), a nylon, a low density polyethylene (LDPE), a high density polyethylene (HDPE), polyvinyl chloride (PVC), polypropylene (PP), polyether sulphone (PES), acrylonitrile butadiene styrene (ABS), or a combination thereof. The filter frame can have flame-retardant properties, and the filter frame can be formed from a flame-retardant material or can includes a flame-retardant additive or coating.

The filter frame can block some of the surface area of the filter that is usable for filtration. However, in various embodiments, the fire-resistant properties of the filter including the fibrous web or sheet that includes the fire-resistant fibers can allow use of less filter frame to provide the overall desired level of fire-resistance of the filter assembly than other filter assemblies that use filters with a lower level of fire-resistance. For example, the filter frame can block less than about 50% of the filter's surface area, or about 10% to less than about 50% of the filter's surface area, or about 10% or less, or less than, equal to, or greater than about 15%, 20, 25, 30, 32, 34, 36, 38, 40, 42, 44, 45, 46, 47, 48, 49, 49.5, 49.9, or about 49.99%. The filter frame can include greater than 50% open area (e.g., area that is unblocked by the filter frame or unblocked by other barriers such that the area is useful for filtration), or about 50% to about 90% open area, or about 50% or more, or less than, equal to, or greater than about 51%, 52, 53, 54, 55, 56, 58, 60, 62, 64, 66, 68, 70, 75, 80, 85, 86, 87, 88, 89, or about 90% or more open area.

The filter assembly including filter frame and filter can have a wide range of aesthetic variations. For example, they may range in color, texture, surface finish, and the like. In some examples the filter can have a different color from the filter frame. In some instances, colors may be chosen to decrease the visible impact of use over time, such as caused by the collection of grease in the filter. In other instances, colors may be chosen to allow the filter assembly to blend-in with the surrounding ventilation hood. The filter can include fibers of multiple colors to create a textured appearance. The filter frame can have coatings to alter coloration and appearance. One example is a metallic coating to provide for a lightweight resin construction with the appearance of metal. Variations can be made in the materials used for either the filter frame, the filter, or for the attachment mechanism between the filter frame and the filter.

### Method of Using the Fire-Resistant Filter.

Various embodiments provide a method of using the fire-resistant filter including the fibrous web or sheet including fire-resistant fibers. The method can be any suitable method of using an embodiment of the fire-resistant filter. The method can include mounting the filter or a filter assembly including the filter for air to be filtered therethrough, such as on a vent hood or air duct. The method can include filtering air through the filter or a filter assembly including the filter. The method can include any one or any combination of the mounting or filtering steps.

### Method of Making the Fire-Resistant Filter.

Various embodiments provide a method of making the fire-resistant filter including the fibrous web or sheet including fire-resistant fibers. The method can be any suitable method that forms an embodiment of the fire-resistant filter. The method can include forming the fibrous web or sheet including the fire-resistant fibers including OPAN, FR rayon, or a combination thereof. The method of making the fire-resistant filter can include combining the fibrous web or sheet with other layers, reinforcement (e.g., a filter frame), coatings, and the like. The method can include combining the fibrous web or sheet with a filter frame to form an embodiment of the filter assembly described herein. The method can include any one or combination of the forming or combining steps.

### EXAMPLES

Various embodiments of the present invention can be better understood by reference to the following Examples which are offered by way of illustration. The present invention is not limited to the Examples given herein.

TABLE 1
Materials.

| Item | Description |
|---|---|
| Fiber 1 | Oxidized polyacrylonitrile (OPAN) staple fiber with a denier diameter of |
| | 5.0dtex × 60 mm and density of 1.37 g/cm³, commercially available under the trade |
| | designation ZOLTEK ™ OX from ZOLTEK CORP., Bridgeton, MO, USA. |
| Fiber 2 | Regenerated cellulose staple fiber incorporating a flame retardant containing |
| | phosphorus and sulfur, with a denier diameter of 3.3dtex × 51 mm and density of |
| | 1.5 g/cm³, commercially available under the trade designation LENZING ™ FR |
| | from LENZING AKTIENGESELLSCHAFT, Lenzing, Austria. |
| Fiber 3 | Polyester staple fiber with a denier diameter of 15d × 50 mm and density of |
| | 1.33-1.38 g/cm³, commercially available under the trade designation T-295 from |
| | INVISTA S.A.R.L., Wichita, KS, USA. |
| Binding fiber | High temperature polyester melty fiber with a denier diameter of 6.7dtex × 60 |
| | mm and density of 1.33-1.38 g/cm³, commercially available under the trade |
| | designation TREVIRA ® T270 from TREVIRA GMBH, Hattersheim, Germany. |

### Example 1. Preparation of Nonwovens

A representative working example airlaid nonwoven web was prepared including a blend of 70% Fiber 1 and 30% Binding fiber by weight. The web was formed using a conventional air-laying web forming machine (available from the Rando Machine Company, Macedon, N.Y., under the trade designation “RANDO WEBBER”), targeting a nominal area weight in the range of 100 grams per square meter (gsm). The collected fibers as formed in the Rando-Webber apparatus were supported on a porous belt and then collected on a 3″ core by winding. The thickness of the output web was estimated to be in the range of approximately 10-20 mm.

Heat-set webs. The collected fibers as formed in the Rando-Webber apparatus were supported on a porous belt and passed through a heating apparatus in which hot air (set at 160° C. (320° F.)) was drawn through the thickness of the collected fibers from air-side to belt-side (i.e., top to bottom). The belt speed was 1.82 m/min (6 feet/min). This resulted in sufficient fiber-fiber melt bonding that the resultant web was a self-supporting web that could be removed from the belt and subjected to further processing as described below.

Needle-tacked webs. Web was needle punched using a conventional needle punching apparatus (commercially available under the trade designation “DILO” from Dilo of Germany), with type #15X18x36x3.5 RB barbed needles (commercially available from Foster Needle Company, Inc., Manitowoc, Wis.) to provide about 15 punches/cm². The barbed needles were punched through the full thickness of the mat. The thickness of the needle-punched, nonwoven web was approximately 10-20 mm ( 1/16 inch).

The list of prepared nonwovens is presented in Table 2. Nonwovens prepared with Binding fiber were heat-set as described above. Individual nonwovens were needle-tacked as described above. Multilayer webs including two (or more) nonwovens were combined (stacked) such that the interior face was in contact with the interior face of the second nonwoven web. Layer 1 designates the front face of the composite web. Prepared multilayer webs are presented in Table 3.

TABLE 2
Prepared Nonwovens A J.

| Component (weight | Nonwoven | | | | | | | | | |
|---|---|---|---|---|---|---|---|---|---|---|
| %) | A | B | C | D | E | F | G | H | I | J |
| Fiber 1 | 100 | 100 | — | — | 60 | 70 | — | 90 | 100 | 100 |
| Fiber 2 | — | — | 100 | 100 | — | — | — | — | — | — |
| Fiber 3 | — | — | — | — | — | — | 100 | — | — | — |
| Binding fiber | — | — | — | — | 40 | 30 | — | 10 | — | — |
| Area Weight (gsm) | 106 | 20 | 110 | 55 | 100 | 100 | 106 | 150 | 151 | 196 |

TABLE 3
Prepared Multilayer Webs 1-3.

| | Multilayer Web | | |
|---|---|---|---|
| | 1 | 2 | 3 |
| Layer 1 Nonwoven | A | G | I |
| Layer 2 Nonwoven | G | A | G |
| Combined Area Weight (gsm) | 212 | 212 | 259 |

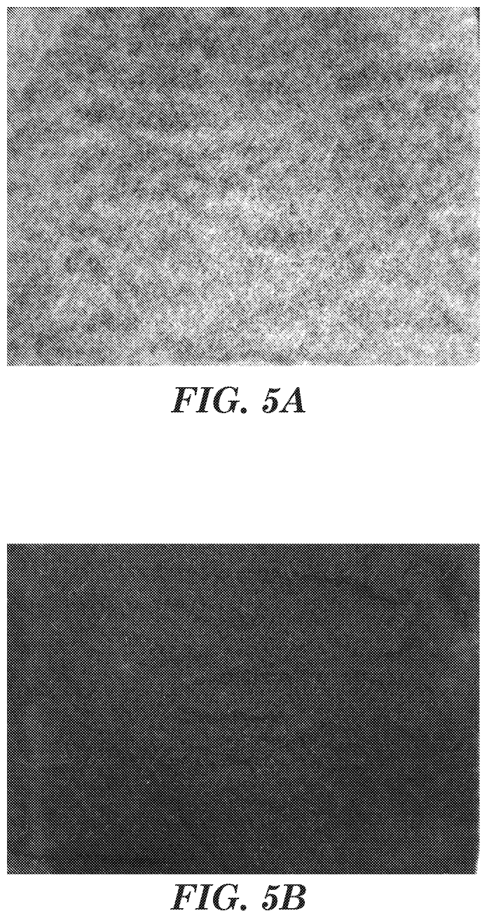

FIG. 5A illustrates a photograph of Layer 2 of Multilayer Web 1 (polyester Fiber 3). FIG. 5B illustrates a photograph of Layer 1 of Multilayer Web 1 (OPAN fiber 1).

### Example 2. Testing of the Web Fire-Resistant Properties

The prepared nonwovens and multi-layer webs from Example 1 were tested for fire-resistant properties following a Bunsen Burner Flame Test. A horizontal ring clamp with an 8 cm diameter opening was attached to a ring stand. An Eisco Natural Gas Bunsen Burner was placed below the ring clamp and the clamp height was adjusted so the distance from the clamp to the top of the burner was 6 cm. Web samples cut into 10 cm×10 cm were placed onto the ring clamp. A 10 cm-long blue flame was established by measuring from the top of the burner to the flame tip. The ignited Bunsen burner was moved under the sample positioned on the ring clamp. The flame was maintained on the sample for 10 seconds. The flame was removed from the sample for 10 seconds and then moved back under the sample/ring clamp for an additional 10 seconds. Webs that pass this test remain intact and the blue flame from the burner does not penetrate the sample, meaning the sample acts as a barrier to the flame and the other side of the sample is not burned or physically deteriorated during the test duration. Webs that fail the test have the flame penetrate the sample, the sample melts & drips, or the sample continues to burn for more than 3 seconds after the flame is removed. If web includes a meltable polymer that material can deteriorate via melting away, but the flame does not penetrate, such that the web acts as a flame-blocking layer. A meltable polymer can become sacrificial during a fire event.

Results from the Bunsen Burner Flame Test on Nonwovens A-G and Multilayer Webs 1-2 are summarized in Table 4.

TABLE 4
Bunsen Burner Flame Test results.

| Sample | Flame Test Rating |
|---|---|
| Nonwoven A | Pass |
| Nonwoven B | Pass |
| Nonwoven C | Pass |
| Nonwoven D | Fail |
| Nonwoven E | Pass |
| Nonwoven F | Pass |
| Nonwoven G | Fail |
| Multilayer Web 1 | Pass |
| Multilayer Web 2 | Fail |

Nonwoven G fails immediately with the sample burning and dripping. Similarly, Multilayer Web 2 also fails the Flame Test. In Multilayer Web 1, Nonwoven A acts as fire-stop to maintain the shape of the web and prevent any dripping.

### Example 3. Test of Flame Penetration in UL 1046 Flame Tunnel

Select nonwovens and a multi-layer webs from Example 1 were tested in a more aggressive flame penetration experiment following the ANSI/UL 1046 Standard, 4^{th} edition, 2010 (Standard for Grease Filters for Exhaust Ducts). Single and multilayer nonwoven webs were soaked until saturated in a bath of oil (Crisco® Frying Oil Blend). The loose webs were then fixed between two perforated metal sheets (Grainger, 22-gauge, 79% open area) and secured into a 20 in.×20 in. metal frame. The webs were subjected to flame penetration testing using the equipment set-up and test method outlined in ANSI/UL 1046. In brief, grease-soaked filters are loaded into a tunnel and subjected to 4,000 BTU/min from ignited natural gas burners for 3 minutes under a constant 200 fpm air flow. Passing webs must remain intact and be easily removed, and flames cannot penetrate beyond 18 inches as an individual flame exceeding 1.0 second or cumulative flames exceeding 20.0 seconds total.

Results from the Flame Tunnel Test on Nonwovens H, J, and Multilayer Web 3 are summarized in Table 5.

TABLE 5
Flame Tunnel Test results.

| | | | Cumulative | | |
|---|---|---|---|---|---|
| | | Individual | flames | | |
| | | flame | past 18 | | |
| | Flames | past 18 | inches | Intact | |
| | beyond | inches | exceed | and | Flame |
| | 18 | exceeds | 20.0 sec. | easily | Tunnel |
| Sample | inches | 1 sec. | total | removed | Rating |
| Metal frame | Yes | >1.0 sec | >20.0 sec | Intact | Fail |
| assembly only | | | | | |
| Nonwoven H | Yes | <1.0 sec | <20.0 sec | Intact | Pass |
| Nonwoven J | Yes | <1.0 sec | <20.0 sec | Intact | Pass |
| Multilayer Web 3 | No | N/A | N/A | Intact | Pass |

All three nonwoven webs in Table 5 pass the flame tunnel test according to the equipment and method in ANSI/UL 1046. The metal framing assembly (frame+front/back perforated sheets), however, immediately fails the test and does not prevent flame penetration. The flame barrier performance of these nonwovens relies on their fire-resistant properties and construction alone without a traditional baffle.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY EMBODIMENTS

The following exemplary embodiments are provided, the numbering of which is not to be construed as designating levels of importance:

Embodiment 1 provides a filter comprising:

a fibrous web or sheet comprising fire-resistant fibers, the fire-resistant fibers comprising oxidized polyacrylonitrile (OPAN), flame-retardant (FR) rayon, or a combination thereof.

Embodiment 2 provides the filter of Embodiment 1, wherein about 60 wt % to about 100 wt % of each of the fire-resistant fibers are independently OPAN or FR rayon.

Embodiment 3 provides the filter of any one of Embodiments 1-2, wherein the fire-resistant fibers comprise FR rayon.

Embodiment 4 provides the filter of any one of Embodiments 1-3, wherein the fire-resistant fibers comprise OPAN.

Embodiment 5 provides the filter of any one of Embodiments 1-4, wherein the fibrous web or sheet passes the Bunsen Burner Flame Test.

Embodiment 6 provides the filter of any one of Embodiments 1-5, wherein a 10 cm×10 cm sample of the fibrous web or sheet placed 6 cm over a 10 cm-long flame from a natural gas Bunsen burner remains intact and experiences no penetration from the flame after a 10-second exposure to the flame followed by a 10-second removal of the flame and further followed by another 10-second exposure to the flame.

Embodiment 7 provides the filter of any one of Embodiments 1-6, wherein the fibrous web or sheet is non-woven.

Embodiment 8 provides the filter of any one of Embodiments 1-7, wherein the fibrous web is bonded.

Embodiment 9 provides the filter of Embodiment 8, wherein the fibrous web comprises a heat-setting material or a melt material.

Embodiment 10 provides the filter of any one of Embodiments 1-9, wherein the fire-resistant fibers are oleophilic or oleophobic.

Embodiment 11 provides the filter of any one of Embodiments 1-10, wherein the OPAN, FR rayon, or combination thereof, is at least about 50 wt % of the fibrous web or sheet.

Embodiment 12 provides the filter of any one of Embodiments 1-11, wherein the OPAN, FR rayon, or combination thereof, is at least about 60 wt % of the fibrous web or sheet.

Embodiment 13 provides the filter of any one of Embodiments 1-12, wherein the fibrous web or sheet comprises at least 25 g/m² of the OPAN, FR rayon, or combination thereof.

Embodiment 14 provides the filter of any one of Embodiments 1-13, wherein the fibrous web or sheet comprises at least 50 g/m² of the OPAN, FR rayon, or combination thereof.

Embodiment 15 provides the filter of any one of Embodiments 1-14, wherein the fire-resistant fibers have a linear mass density of about 0.5 to about 20 denier.

Embodiment 16 provides the filter of any one of Embodiments 1-15, wherein the fire-resistant fibers have a linear mass density of about 3 to about 7 denier.

Embodiment 17 provides the filter of any one of Embodiments 1-16, wherein the fire-resistant fibers have a length of about 0.001 to about 10 cm.

Embodiment 18 provides the filter of any one of Embodiments 1-17, wherein the fire-resistant fibers have a length of about 2 cm to about 8 cm

Embodiment 19 provides the filter of any one of Embodiments 1-18, wherein the fibrous web or sheet further comprises polyacrylonitrile (PAN), polyphenylene sulfide (PPS), polyethylene terephthalate (PET), polypropylene (PP), kapok fiber, poly(lactic acid) (PLA), cotton, nylon, polyester, rayon, wool, or a combination thereof.

Embodiment 20 provides the filter of any one of Embodiments 1-19, wherein the fibrous web or sheet further comprises a coating, a flame retardant, fibers, a heat-setting material, a melt material, a metal fiber, a glass fiber, a ceramic fiber, an aramid fiber, a sorbent, an intumescent material, mica, diatomaceous earth, glass bubbles, carbon particles, or a combination thereof.

Embodiment 21 provides the filter of any one of Embodiments 1-20, wherein the fibrous web or sheet is about 10 to about 400 g/m².

Embodiment 22 provides the filter of any one of Embodiments 1-21, wherein the fibrous web or sheet is about 80 to about 250 g/m².

Embodiment 23 provides the filter of any one of Embodiments 1-22, wherein the filter is pleated, flat, or a combination thereof.

Embodiment 24 provides the filter of any one of Embodiments 1-23, comprising a single layer of the fibrous web or sheet.

Embodiment 25 provides the filter of any one of Embodiments 1-24, comprising multiple layers of the fibrous web or sheet.

Embodiment 26 provides the filter of any one of Embodiments 1-25, further comprising one or more additional layers that are each independently discrete or at least partially blended and are each independently a fire-retardant layer, a non-fire-retardant layer, a woven layer, a non-woven layer, a metal layer, an adhesive layer, a coating, a powder, a sorbent layer, a gradient layer, a sacrificial layer, grease-degrading layers, a resin layer, a scrim layer, or a combination thereof.

Embodiment 27 provides the filter of claim 26, wherein the one or more additional layers each independently comprise a fire-retardant, an adhesive, a heat-setting material, a melt material, a fire-resistant fiber, a coated fiber, powder, metal, glass, ceramic, a metal fiber, a glass fiber, an aramid fiber, a ceramic fiber, a sorbent, an intumescent material, mica, diatomaceous earth, glass bubbles, carbon particles, or a combination thereof.

Embodiment 28 provides the filter of any one of Embodiments 26-27, wherein the one or more additional layers are each independently unbonded, adhesive-laminated, heat-bonded, ultrasonically bonded, needle-tacked, physically attached by fasteners, or a combination thereof.

Embodiment 29 provides the filter of any one of Embodiments 1-28, wherein one major face of the fibrous web or sheet comprises an additional layer and the opposite major face of the fibrous web or sheet is free of additional layers.

Embodiment 30 provides the filter of any one of Embodiments 1-29, wherein both major faces of the fibrous web or sheet comprise an additional layer.

Embodiment 31 provides the filter of any one of Embodiments 1-30, wherein the filter is mountable in an air filter holder, such as in a slot, with magnets or adhesive, with mechanical fasteners, as a self-supporting filter, with a cover screen to hold the air filter in place, via a frame or fascia for the filter that can be temporarily or permanently attached, or a combination thereof.

Embodiment 32 provides a filter assembly, comprising:

the filter of any one of Embodiments 1-31; and

a filter frame.

Embodiment 33 provides the filter assembly of Embodiment 32, wherein the filter assembly is a rigid, self-supporting structure.

Embodiment 34 provides the filter assembly of any one of Embodiments 32-33, wherein the filter frame comprises aluminum, stainless steel, tin, copper, glass, fiberglass, a polyimide (PI), a polybenzoxazole (PBO), a polybenzimidazole (PBI), a polybenzthiazole (PBT), a polyetherimide (PEI), a polyethylene terephthalate polyester (PET), a nylon, a low density polyethylene (LDPE), a high density polyethylene (HDPE), polyvinyl chloride (PVC), polypropylene (PP), polyether sulphone (PES), acrylonitrile butadiene styrene (ABS), or a combination thereof.

Embodiment 35 provides the filter assembly of any one of Embodiments 32-34, wherein the filter frame comprises a flame-retardant additive.

Embodiment 36 provides the filter assembly of any one of Embodiments 32-35, wherein the filter frame is secured to the filter using ultrasonic bonding, adhesive, heat bonding, a mechanical attachment mechanism, or a combination thereof.

Embodiment 37 provides the filter assembly of claim 32-36, wherein the filter frame blocks less than about 50% of the filter's surface area.

Embodiment 38 provides the filter assembly of any one of Embodiments 32-37, wherein the filter frame blocks about 10% to less than about 50% of the filter's surface area.

Embodiment 39 provides the filter assembly of any one of Embodiments 32-38, wherein the filter assembly comprises greater than about 50% open area.

Embodiment 40 provides the filter assembly of any one of Embodiments 32-39, wherein the filter assembly comprises greater than about 50% to less than or equal to about 90% open area.

Embodiment 41 provides a self-supporting filter assembly comprising:

a fibrous non-woven web or sheet comprising fire-resistant fibers, the fire-resistant fibers comprising oxidized polyacrylonitrile (OPAN), FR rayon, or a combination thereof, wherein the OPAN, FR rayon, or combination thereof, is at least about 60 wt % of the fibrous web or sheet; and

a filter frame.

Embodiment 42 provides a method of using the filter of any one of Embodiments 1-31, the method comprising:

mounting the filter or the filter assembly of any one of Embodiments 32-40 comprising the filter for air to be filtered therethrough.

Embodiment 43 provides a method of using the filter of any one of Embodiments 1-31, the method comprising:

filtering air through the filter or the filter assembly of any one of Embodiments 32-40 comprising the filter.

Embodiment 44 provides a method of making the filter of Embodiment 1, the method comprising:

forming the fibrous web or sheet comprising the fire-resistant fibers comprising OPAN, FR rayon, or a combination thereof.

Embodiment 45 provides the filter, filter assembly, or method of any one or any combination of Embodiments 1-44 optionally configured such that all elements or options recited are available to use or select from.

What is claimed is:

1. A filter comprising:
a fibrous web or sheet comprising fire-resistant fibers, the fire-resistant fibers comprising oxidized polyacrylonitrile (OPAN), flame-retardant (FR) rayon, or a combination thereof.

2. The filter of claim 1, wherein the fire-resistant fibers comprise OPAN.

3. The filter of claim 1, wherein the fibrous web or sheet passes the Bunsen Burner Flame Test.

4. The filter of claim 1, wherein the fibrous web or sheet is non-woven.

5. The filter of claim 1, wherein the fibrous web is bonded and comprises a heat-setting material or a melt material.

6. The filter of claim 1, wherein the OPAN, FR rayon, or combination thereof, is at least about 50 wt % of the fibrous web or sheet.

7. The filter of claim 1, wherein the fibrous web or sheet comprises at least 25 g/m² of the OPAN, FR rayon, or combination thereof.

8. The filter of claim 1, wherein the fibrous web or sheet is about 10 to about 400 g/m².

9. The filter of claim 1, wherein the fibrous web or sheet further comprises polyacrylonitrile (PAN), polyphenylene sulfide (PPS), polyethylene terephthalate (PET), polypropylene (PP), kapok fiber, poly(lactic acid) (PLA), cotton, nylon, polyester, rayon, wool, or a combination thereof.

10. The filter of claim 1, wherein the fibrous web or sheet further comprises a coating, a flame retardant, fibers, a heat-setting material, a melt material, a metal fiber, a glass fiber, a ceramic fiber, an aramid fiber, a sorbent, an intumescent material, mica, diatomaceous earth, glass bubbles, carbon particles, or a combination thereof.

11. The filter of claim 1, further comprising one or more additional layers that are each independently discrete or at least partially blended and are each independently a fire-retardant layer, a non-fire-retardant layer, a woven layer, a non-woven layer, a metal layer, an adhesive layer, a coating, a powder, a sorbent layer, a gradient layer, a sacrificial layer, grease-degrading layers, a resin layer, a scrim layer, or a combination thereof.

12. A filter assembly, comprising:
the filter of claim 1; and
a filter frame.

13. The filter assembly of claim 12, wherein the filter assembly is a rigid, self-supporting structure.

14. The filter assembly of claim 12, wherein the filter frame comprises a flame-retardant additive.

15. The filter assembly of claim 12, wherein the filter frame is secured to the filter using ultrasonic bonding, adhesive, heat bonding, a mechanical attachment mechanism, or a combination thereof.

16. The filter assembly of claim 12, wherein the filter assembly comprises greater than about 50% open area.

17. A self-supporting filter assembly comprising:
a fibrous non-woven web or sheet comprising fire-resistant fibers, the fire-resistant fibers comprising oxidized polyacrylonitrile (OPAN), flame-retardant (FR) rayon, or a combination thereof, wherein the OPAN, FR rayon, or combination thereof, is at least about 60 wt % of the fibrous web or sheet; and
a filter frame.

18. A method of using the filter of claim 1, the method comprising:
mounting the filter or a filter assembly comprising the filter for air to be filtered therethrough.

19. A method of using the filter of claim 1, the method comprising:
filtering air through the filter or a filter assembly comprising the filter.

20. A method of making the filter of claim 1, the method comprising:
forming the fibrous web or sheet comprising the fire-resistant fibers comprising OPAN, FR rayon, or a combination thereof.
